(19) United States
(12) Patent Application Publication
(10) Pub. No.: US 2010/0311589 A1
(43) Pub. Date: Dec. 9, 2010

(54) CARBAMOYL TRIAZOLINONE BASED HERBICIDE COMBINATIONS AND METHOD OF USE

(75) Inventors: Hideo Nakatani, Tokyo (JP); Noel Burchell Leibbrandt, Mount Edgecombe (ZA); Joao M. Miyasaki, Sao Paulo-SP (BR)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: ARYSTA LIFESCIENCE CORPORATION, Tokyo (JP)

(21) Appl. No.: 12/796,511

(22) Filed: Jun. 8, 2010

Related U.S. Application Data
(60) Provisional application No. 61/185,363, filed on Jun. 9, 2009.

(51) Int. Cl. A01N 43/66; A01N 43/653; A01P 13/02

(52) U.S. Cl. 504/134; 504/139

(57) ABSTRACT

The invention relates to herbicidal active compound combinations comprising, carbamoyltriazolinones, and herbicidally active compounds, which combinations are suitable for controlling weeds.

### RELATED APPLICATIONS

This application claims priority to application Ser. No. 61/185,363, filed Jun. 9, 2009, which is expressly incorporated by reference herein in its entirety.

### FIELD OF THE INVENTION

The invention relates to herbicidal, active compound combinations composed of known carbamoyltriazolinones and herbicidally active compounds, which can be used successfully for controlling weeds.

### INTRODUCTION

Herbicides play an important role for weed control in crop production. Applying combinations of herbicidal compounds may enhance the herbicidal effectiveness.

### BRIEF DESCRIPTION OF THE FIGURE

FIG. 1 shows a carbamoyltriazolinone of the general formula (I).

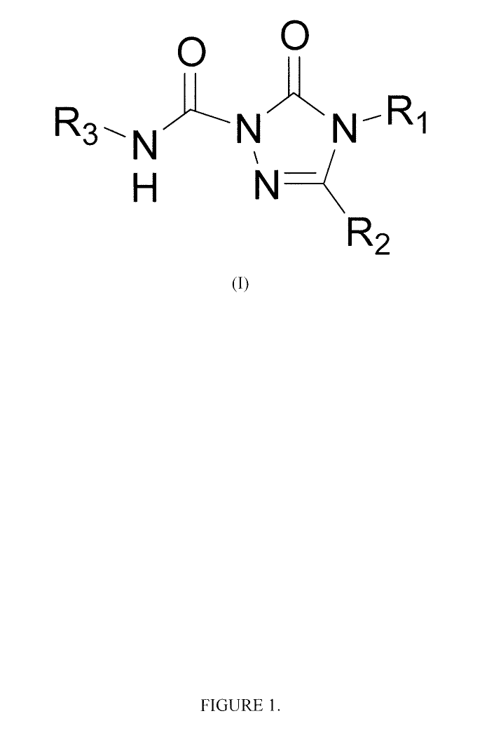

### SUMMARY OF THE INVENTION

Embodiments herein, accordingly, provides compositions comprising a synergistic effective amount of a combination of a first compound and a second component, wherein said first compound is a compound of the formula (I)

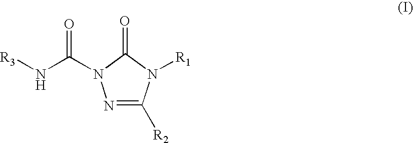

wherein:

R₁ is selected from the group consisting of hydrogen, hydroxyl, amino, or in each case optionally substituted alkyl, alkenyl, alkinyl, alkoxy, alkenyloxy, alkinyloxy, alkylamino, alkenylamino, alkenylamino, alkylideneamino, dialkylamino, cycloalkyl, cycloalkylalkyl, aryl and arylalkyl, any of which may be optionally substituted;

R₂ is selected from the group consisting of alkyl, alkenyl, alkinyl, alkoxy, alkenyloxy, alkinyloxy, alkylthio, alkenylthio, alkinylthio, alkylamino, alkenylamino, alkinylamino, dialkylamino, cycloalkyl, cycloalkyloxy, cycloalkylalkyl, aryl, aryloxy, arylthio, arylamino and arylalkyl, any of which may be optionally substituted;

R₃ is selected from the group consisting of alkyl, alkenyl, alkinyl, cycloalkyl, cycloalkylalkyl, arylalkyl, arylalkenyl and arylalkinyl, any of which may be optionally substituted; and
said second component is selected from 2-[(2-chlorophenyl)methyl]-4,4-dimethyl-3-isoxazolidinone, 3-cyclohexyl-6-dimethylamino-1-methyl-1,3,5-triazine-2,4(1H,3H)-dione, 4-methyl-2-chlorophenoxyacetic acid, 2-chloro-4-(ethylamine)-6-(isopropylamine)-s-triazine, 2-chloro-N-(2-ethyl-6-methylphenyl)-N-[(1-methylethoxy)methyl]acetamide, an herbicide of the chloroacetamide class, (aka, the chloroacetanilide class) and mixtures thereof.

In various aspects, an herbicide of the chloroacetamide class include 2-chloro-N-(2-ethyl-6-methylphenyl)-N-[(1-methylethoxy)methyl]acetamide (Propisochlor), 2-chloro-N-ethoxymethyl-6′-ethylacet-o-toluidide (Acetochlor), 2-chloro-N-(2-ethyl-6-methylphenyl)-N-(2-methoxy-1-methylethyl)acetamide, (Metolachlor), 2-chloro-N-(2-ethyl-6-methylphenyl)-N-[(1S)-2-methoxy-1-methylethyl]acetamide (S-Metolachlor), 2-chloro-N-(2,6-diethylphenyl)-N-(methoxymethyl)acetamide (Alachlor), and N-(butoxymethyl)-2-chloro-N-(2,6-diethylphenyl)acetamide (Butachlor), N-[[(2Z)-2-butenyloxy]methyl]-2-chloro-N-(2,6-diethylphenyl)acetamide (Butenachlor), 2-chloro-N-(2,6-dimethylphenyl)-N-[(2-methylpropoxy)methyl]acetamide (Delachlor), N-(chloroacetyl)-N-(2,6-diethylphenyl)glycine (Diethatyl), 2-chloro-N-(2,6-dimethylphenyl)-N-(2-methoxyethyl)acetamide (Dimethachlor), 2-chloro-N-(2,6-dimethylphenyl)-N-(1H-pyrazol-1-ylmethyl)acetamide (Metazachlor), 2-chloro-N-(2,6-diethylphenyl)-N-(2-propoxyethyl)acetamide (Pretilachlor), 2-chloro-N-(1-methylethyl)-N-phenylacetamide (Propachlor), 2-chloro-N-(1-methyl-2-propynyl)-N-phenylacetamide (Prynachlor), N-(butoxymethyl)-2-chloro-N-[2-(1,1-dimethylethyl)-6-methylphenyl]acetamide (Terbuchlor), 2-chloro-N-(2,6-dimethylphenyl)-N-[(3-methoxy-2-thienyl)methyl]acetamide(Thenylchlor), and 2-chloro-N-(2,3-dimethylphenyl)-N-(1-methylethyl)acetamide (Xylachlor).

In one embodiment, R₁ is an optionally substituted amino. In a further embodiment, R₁ is NH₂. In one embodiment, R₂ is an optionally substituted alkyl. In a further embodiment, R₂ is i-propyl. In one embodiment, R₃ is an optionally substituted alkyl. In a further embodiment, R₃ is t-butyl.

In certain embodiments, a first compound is 4-amino-5-isopropyl-2-(tert-butyl-aminocarbonyl)-2,4-dihydro-3H-1,2,4-triazol-3-one. In certain embodiments, a second component is 2-chloro-N-(2-ethyl-6-methylphenyl)-N-[(1-methylethoxy)methyl]acetamide. In certain embodiments, a second component is 2-[(2-chlorophenyl)methyl]-4,4-dimethyl-3-isoxazolidinone and 3-cyclohexyl-6-dimethylamino-1-methyl-1,3,5-triazine-2,4(1H,3H)-dione. In certain embodiments, a second component is 4-methyl-2-chlorophenoxyacetic acid.

In another embodiment, a composition further includes an adjuvant. In a further embodiment, an adjuvant is an ethoxylated propoxylated fatty amine or a polyether-polymethylsiloxane-copolymer. In yet a further embodiment, a composition further includes a herbicidally acceptable diluent or carrier.

In one embodiment, a second component is present in the composition in an amount ranging from 0.001 to 1000 parts by weight per part by weight of the first component. In a further embodiment, a second component is present in the composition in an amount ranging from 0.02 to 500 parts by weight per part by weight of the first component. In yet a further embodiment, a second component is present in the composition in an amount ranging from 0.05 to 100 parts by weight per part by weight of the first component.

In another embodiment of the invention, a composition is in a solid or liquid form of an emulsifiable concentrate, wettable powder, granule, dust, oil spray or aerosol.

In embodiments, compositions described herein provides synergistic control of one or more weeds. In one embodiment, a weed is Amaranthus, Digitaria, Cyperus or Euphorbia.

Embodiments herein also provide methods for selective control of weeds. In one aspect, a method includes contacting a composition comprising a synergistic effective amount of a combination of a first compound and a second component onto a crop plant or a non-crop area in need of weed control or at risk of undesirable weeds, in an amount effective to provide weed control in the crop, wherein said first compound is a compound of the formula (I)

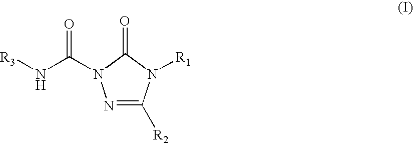

wherein:

R₁ is selected from the group consisting of hydrogen, hydroxyl, amino, or in each case optionally substituted alkyl, alkenyl, alkinyl, alkoxy, alkenyloxy, alkinyloxy, alkylamino, alkenylamino, alkenylamino, alkylideneamino, dialkylamino, cycloalkyl, cycloalkylalkyl, aryl and arylalkyl, any of which may be optionally substituted;

R₂ is selected from the group consisting of alkyl, alkenyl, alkinyl, alkoxy, alkenyloxy, alkinyloxy, alkylthio, alkenylthio, alkinylthio, alkylamino, alkenylamino, alkinylamino, dialkylamino, cycloalkyl, cycloalkyloxy, cycloalkylalkyl, aryl, aryloxy, arylthio, arylamino and arylalkyl, any of which may be optionally substituted;

R₃ is selected from the group consisting of alkyl, alkenyl, alkinyl, cycloalkyl, cycloalkylalkyl, arylalkyl, arylalkenyl and arylalkinyl, any of which may be optionally substituted; and
said second component is selected from 2-[(2-chlorophenyl)methyl]-4,4-dimethyl-3-isoxazolidinone, 3-cyclohexyl-6-dimethylamino-1-methyl-1,3,5-triazine-2,4(1H,3H)-dione, 4-methyl-2-chlorophenoxyacetic acid, 2-chloro-4-(ethylamine)-6-(isopropylamine)-s-triazine, N-ethyl-N′-(1-methylethyl)-6-(methylthio)-1,3,5-triazine-2,4-diamine, N-(3,4-dichlophenyl)-N,N-dimethyl urea, 5-cyclopropyl-4-(2-methylsulfonyl-4-trifluoromethylbenzoyl)isoxazole, 4-amino-6-tert-butyl-4,5-dihydro-3-methyltio-1,2,4-triazin-5-one, 1-(5-tert-butyl-1,3,4-thiadiazol-2-yl)-1,3-dimethylurea, 2′,4′-dichloro-5′-(4-difluoromethyl-4,5-dihydro-3-methyl-5-oxo-1H-1,2,4-triazol-1-yl)methanesulfonanilide, 2-(4-mesyl-2-nitrobenzoyl)cyclohexane-1,3-dione, N-(phosphonomethyl)glycine, dimethylamine salt of 2,4-dichlorophenoxyacetic acid, an herbicide of the chloroacetamide class, and mixtures thereof.

In various aspects, an herbicide of the chloroacetamide class includes 2-chloro-N-(2-ethyl-6-methylphenyl)-N-[(1-methylethoxy)methyl]acetamide (Propisochlor), 2-chloro-N-ethoxymethyl-6′-ethylacet-o-toluidide (Acetochlor), 2-chloro-N-(2-ethyl-6-methylphenyl)-N-(2-methoxy-1-methylethyl)acetamide (Metolachlor), 2-chloro-N-(2-ethyl-6-methylphenyl)-N-[(1S)-2-methoxy-1-methylethyl]acetamide (S-Metolachlor), 2-chloro-N-(2,6-diethylphenyl)-N-(methoxymethyl)acetamide (Alachlor), and N-(butoxymethyl)-2-chloro-N-(2,6-diethylphenyl)acetamide (Butachlor), N-[[(2Z)-2-butenyloxy]methyl]-2-chloro-N-(2,6-diethylphenyl)acetamide (Butenachlor), 2-chloro-N-(2,6-dimethylphenyl)-N-[(2-methylpropoxy)methyl]acetamide (Delachlor), N-(chloroacetyl)-N-(2,6-diethylphenyl)glycine (Diethatyl), 2-chloro-N-(2,6-dimethylphenyl)-N-(2-methoxyethyl)acetamide (Dimethachlor), 2-chloro-N-(2,6-dimethylphenyl)-N-(1H-pyrazol-1-ylmethyl)acetamide (Metazachlor), 2-chloro-N-(2,6-diethylphenyl)-N-(2-propoxyethyl)acetamide (Pretilachlor), 2-chloro-N-(1-methylethyl)-N-phenylacetamide (Propachlor), 2-chloro-N-(1-methyl-2-propynyl)-N-phenylacetamide (Prynachlor), N-(butoxymethyl)-2-chloro-N-[2-(1,1-dimethylethyl)-6-methylphenyl]acetamide (Terbuchlor), 2-chloro-N-(2,6-dimethylphenyl)-N-[(3-methoxy-2-thienyl)methyl]acetamide (Thenylchlor), and 2-chloro-N-(2,3-dimethylphenyl)-N-(1-methylethyl)acetamide (Xylachlor).

In certain embodiments, a crop plant is selected from cereals, rice, maize, sorghum, sugar cane, cotton, canola, turf, barley, potato, sweet potato, sunflower, rye, oats, wheat, corn, soybean, sugar beet, tobacco, safflower, tomato, alfalfa, pineapple and cassava.

In one embodiment, a second component is selected from N-ethyl-N′-(1-methylethyl)-6-(methylthio)-1,3,5-triazine-2,4-diamine, N-(3,4-dichlophenyl)-N,N-dimethyl urea, 5-cyclopropyl-4-(2-methylsulfonyl-4-trifluoromethylbenzoyl)isoxazole and 4-amino-6-tert-butyl-4,5-dihydro-3-methyltio-1,2,4-triazin-5-one. In one embodiment, a crop plant is selected from the group consisting of sugar cane, pineapple, cassava, turf and pasture.

In one embodiment, a composition further comprises 2-[(2-chlorophenyl)methyl]-4,4-dimethyl-3-isoxazolidinone and/or 3-cyclohexyl-6-dimethylamino-1-methyl-1,3,5-triazine-2,4(1H,3H)-dione. In one embodiment, a crop plant is sugar cane, turf and pasture.

In one embodiment, a composition further comprises 4-methyl-2-chlorophenoxyacetic acid. In an additional embodiment, a composition further includes an adjuvant. In a further embodiment, an adjuvant is an ethoxylated propoxylated fatty amine or a polyether-polymethylsiloxane-copolymer. In one embodiment, a crop plant is sugar cane, turf and pasture.

In one embodiment, a first compound is 4-amino-5-isopropyl-2-(tert-butyl-aminocarbonyl)-2,4-dihydro-3H-1,2,4-triazol-3-one.

In one embodiment, a composition is contacted at an application rate of from 0.01 kg/ha to 5.00 kg/ha of the first compound and from 0.5 kg/ha to 10.00 kg/ha of the second component to the crop. In a further embodiment, a composition is contacted at an application rate of from 0.03 kg/ha to 3.00 kg/ha of the first compound to the crop. In yet a further embodiment, a composition is contacted at an application rate of from 0.05 kg/ha to 5.00 kg/ha of the second component to the crop.

In one embodiment, a composition is applied as a pre-emergence treatment. In another embodiment, the composition is applied as a post-emergence treatment.

In certain embodiments, a weed is Amaranthus, Digitaria, Cyperus or Euphorbia.

### DETAILED DESCRIPTION

A series of active compounds from the carbamoyltriazolinone series, used jointly with herbicidally active compounds from various classes of substances, show a synergistic activity with regard to the action against weeds and can be employed as products for controlling (e.g. limiting growth) monocotyledonous (e.g. glasses) or dicotyledonous weeds (e.g. board leaves) in crops of useful plants such as, for example, in barley, maize, rice, soya beans, sunflowers, wheat, pineapple, Cassava, sugar cane, corn and Agave. but also for the selective, semi- and non-selective control of monocotyledonous and dicotyledonous weeds.

Disclosed herein are herbicidal compositions, characterized by an effective content of composition comprising

(a) a carbamoyltriazolinone of the general formula (I)

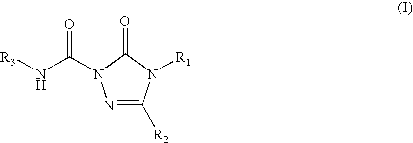

wherein:

R₁ represents hydrogen, hydroxyl, amino, or in each case optionally substituted alkyl, alkenyl, alkinyl, alkoxy, alkenyloxy, alkinyloxy, alkylamino, alkenylamino, alkenylamino, alkylideneamino, dialkylamino, cycloalkyl, cycloalkylalkyl, aryl and arylalkyl, any of which may be optionally substituted,

R₂ represents alkyl, alkenyl, alkinyl, alkoxy, alkenyloxy, alkinyloxy, alkylthio, alkenylthio, alkinylthio, alkylamino, alkenylamino, alkinylamino, dialkylamino, cycloalkyl, cycloalkyloxy, cycloalkylalkyl, aryl, aryloxy, arylthio, arylamino and arylalkyl, any of which may be optionally substituted, and

R₃ represents alkyl, alkenyl, alkinyl, cycloalkyl, cycloalkylalkyl, arylalkyl, arylalkenyl and arylalkinyl, any of which may be optionally substituted.

(Active Compounds of Group a)

(b) one or more compounds from a second component of herbicides containing the active compounds mentioned herein below:, 2-[(2-chlorophenyl)methyl]-4,4-dimethyl-3-isoxazolidinone (Clomazone), 3-cyclohexyl-6-dimethylamino-1-methyl-1,3,5-triazine-2,4(1H,3H)-dione (Hexazinone), 4-methyl-2-chlorophenoxyacetic acid (MCPA), 2-chloro-4-(ethylamine)-6-(isopropylamine)-s-triazine (Atrazine), N-ethyl-N′-(1-methylethyl)-6-(methylthio)-1,3,5-triazine-2,4-diamine (Ametryn), N-(3,4-dichlophenyl)-N,N-dimethyl urea (Diuron), 5-cyclopropyl-4-(2-methylsulfonyl-4-trifluoromethylbenzoyl)isoxazole (Isoxaflutole), 4-amino-6-tert-butyl-4,5-dihydro-3-methyltio-1,2,4-triazin-5-one (Metribuzin), 1-(5-tert-butyl-1,3,4-thiadiazol-2-yl)-1,3-dimethylurea (Tebuthiuron), 2′,4′-dichloro-5′-(4-difluoromethyl-4,5-dihydro-3-methyl-5-oxo-1H-1,2,4-triazol-1-yl)methanesulfonanilide (Sulfentrazone), 2-(4-mesyl-2-nitrobenzoyl)cyclohexane-1,3-dione (Mesotrione), N-(phosphonomethyl)glycine (Glyphosate), dimethylamine salt of 2,4-dichlorophenoxyacetic acid (2,4-D Amine), an herbicide of the chloroacetamide class, for example, 2-chloro-N-(2-ethyl-6-methylphenyl)-N-[(1-methylethoxy)methyl]acetamide (Propisochior), 2-chloro-N-ethoxymethyl-6′-ethylacet-o-toluidide (Acetochlor), 2-chloro-N-(2-ethyl-6-methylphenyl)-N-(2-methoxy-1-methylethyl)acetamide (Metolachlor), 2-chloro-N-(2-ethyl-6-methylphenyl)-N-[(15)-2-methoxy-1-methylethyl]acetamide (S-Metolachlor), 2-chloro-N-(2,6-diethylphenyl)-N-(methoxymethyl)acetamide (Alachlor), and N-(butoxymethyl)-2-chloro-N-(2,6-diethylphenyl)acetamide (Butachlor), N-[[(2Z)-2-butenyloxy]methyl]-2-chloro-N-(2,6-diethylphenyl)acetamide (Butenachlor), 2-chloro-N-(2,6-dimethylphenyl)-N-[(2-methylpropoxy)methyl]acetamide (Delachlor), N-(chloroacetyl)-N-(2,6-diethylphenyl)glycine (Diethatyl), 2-chloro-N-(2,6-dimethylphenyl)-N-(2-methoxyethyl)acetamide (Dimethachlor), 2-chloro-N-(2,6-dimethylphenyl)-N-(1H-pyrazol-1-ylmethyl)acetamide (Metazachlor), 2-chloro-N-(2,6-diethylphenyl)-N-(2-propoxyethyl)acetamide (Pretilachlor), 2-chloro-N-(1-methylethyl)-N-phenylacetamide (Propachlor), 2-chloro-N-(1-methyl-2-propynyl)-N-phenylacetamide (Prynachlor), N-(butoxymethyl)-2-chloro-N-[2-(1,1-dimethylethyl)-6-methylphenyl]acetamide (Terbuchlor), 2-chloro-N-(2,6-dimethylphenyl)-N-[(3-methoxy-2-thienyl)methyl]acetamide (Thenylchlor), and 2-chloro-N-(2,3-dimethylphenyl)-N-(1-methylethyl)acetamide (Xylachlor), and mixtures thereof.

(Active Compounds of Group b)

The meanings of the radicals mentioned in the above formula (I) are illustrated hereinbelow.

In certain embodiments, R₁ represents hydrogen, hydroxyl, amino, or represents alkyl, alkenyl, alkinyl, alkoxy, alkenyloxy, alkinyloxy, alkylamino, alkenylamino, alkinylamino, alkylideneamino or dialkylamino, each of which has up to 6 carbon atoms and each of which is optionally substituted by halogen or cyano, or represents cycloalkyl, cycloalkylalkyl, each of which has 3 to 6 carbon atoms in the cycloalkyl groups and, if appropriate, 1 to 4 carbon atoms in the alkyl group and each of which is optionally substituted by halogen, cyano or C₁-C₄-alkyl, or represents phenyl or phenyl-C₁-C₄-alkyl, each of which is optionally substituted by halogen, cyano, C₁-C₄-alkyl or C₁-C₄-alkoxy.

In certain embodiments, R₂ represents alkyl, alkenyl, alkinyl, alkoxy, alkenyloxy, alkinyloxy, alkylthio, alkenylthio, alkinylthio, alkylamino, alkenylamino, alkinylamino or dialkylamino, each of which has up to 6 carbon atoms and each of which is optionally substituted by halogen, cyano, C₁-C₄-alkoxy or C₁-C₄-alkylthio, or represents cycloalkyl, cycloalkyloxy or cycloalkylalkyl, each of which has 3 to 6 carbon atoms in the cycloalkyl groups and, if appropriate, 1 to 4 carbon atoms in the alkyl group and each of which is optionally substituted by halogen, cyano or C₁-C₄-alkyl, or represents phenyl, phenoxy, phenylthio, phenylamino or phenyl-C₁-C₄-alkyl, each of which is optionally substituted by halogen, cyano, C₁-C₄-alkyl or C₁-C₄-alkoxy.

In certain embodiments, R₃ represents alkyl, alkenyl or alkinyl, each of which has up to 10 carbon atoms and each of which is optionally substituted by halogen, cyano, C₁-C₄-alkoxy, C₁-C₄-alkylthio, C₁-C₄-alkylsulphinyl, C₁-C₄-alkylsulphonyl, C₁-C₄-alkylamino or di-(C₁-C₄-alkyl)amino, or represents cycloalkyl or cycloalkylalkyl, each of which has 3 to 6 carbon atoms in the cycloalkyl moiety and, if appropriate,) to 4 carbon atoms in the alkyl moiety and each of which is optionally substituted by halogen, cyano or C₁-C₄-alkyl, or represents phenyl-C₁-C₆-alkyl, phenyl-C₂-C₆-alkenyl or phenyl-C₂-C₆-alkinyl, each of which is optionally substituted by halogen, cyano, C₁-C₄-alkyl or C₁-C₄-alkoxy.

In certain embodiments, R₁ represents hydrogen, hydroxyl, amino, or represents methyl, ethyl, n- or i-propyl, n-, s- or t-butyl, propenyl, butenyl, propinyl or butinyl, methoxy, ethoxy, n- or i-propoxy, n-, s- or t-butoxy, propenyloxy, butenyloxy, propinyloxy or butinyloxy, methylamino, ethylamino, n- or i-propylamino, n-, s- or t-butylamino, propenylamino, butenylamino, propiny-lamino or butinylamino, ethylideneamino, propylideneamino, butylideneamino, dimethylamino or diethylamino, each of which is optionally substituted by fluorine, chlorine or cyano, or represents cyclopropyl, cyclobutyl, cyclopentyl, cyclohexyl, cyclopropylmethyl, cyclobutylmethyl, cyclopentylmethyl or cyclohexylmethyl, each of which is optionally substituted by fluorine, chlorine, bromine, cyano, methyl, ethyl, n- or i-propyl, or represents phenyl or benzyl, each of which is optionally substituted by fluorine, chlorine, bromine, cyano, methyl, ethyl, n- or i-propyl, n-, s- or t-butyl, methoxy or ethoxy.

In certain embodiments, R₂ represents methyl, ethyl, n- or i-propyl, n-, s- or t-butyl, propenyl, butenyl, propinyl, butinyl, methoxy, ethoxy, n- or i-propoxy, n-, s- or t-butoxy, propenyloxy, butenyloxy, propinyloxy, butinyloxy, methylthio, ethylthio, n or i-propylthio, n-, s- or t-butylthio, propenylthio, butenylthio, propinylthio, butinylthio, methylamino, ethylamino, n- or i-propylamino, n-, s- or t-butylamino, propenylamino, butenylamino, propinylamino, butinylamino, dimethyl-lamino or diethylamino, each of which is optionally substituted by fluorine, chlorine, cyano, methoxy, ethoxy, n- or i-propoxy, methylthio, ethylthio, n- or i-propylthio, or represents cyclopropyl, cyclobutyl, cyclopentyl, cyclohexyl, cyclopropyloxy, cyclobutyloxy, cyclopentyloxy, cyclohexyloxy, cyclopropylmethyl, cyclobutylmethyl, cyclopentylmethyl or cyclohexylmethyl, each of which is optionally substituted by fluorine, chlorine, bromine, cyano, methyl, ethyl, n- or i-propyl, or represents phenyl, phenoxy, phenylthio, phe-nylamino or benzyl, each of which is optionally substituted by fluorine, chlorine, bromine, cyano, methyl, ethyl, n- or i-propyl, n-, s- or t-butyl, methoxy or ethoxy.

In certain embodiments, R₃ represents methyl, ethyl, n- or i-propyl, n-, s- or t-butyl, propenyl, butenyl, pentenyl, hexenyl, propinyl, butinyl, pentinyl or hexinyl, each of which is optionally substituted by fluorine, cyano, methoxy, ethoxy, n- or i-propoxy, n-, s- or t-butoxy, methylthio, ethylthio, n- or i-propylthio, n-, s-, or t-butylthio, methylsulphinyl, ethylsulphinyl, methylsulphonyl, ethylsulphonyl, methylamino, ethylamino, n- or i-propylamino, n-, s- or t-butylamino, dimethylamino, diethylamino, dipropylamino or dibutylamino, or represents cyclopropyl, cyclobutyl, cyclopentyl, cyclohexyl, cyclopropylmethyl, cyclobutylmethyl, cyclopentylmethyl, cyclohexylmethyl, cyclohexylethyl or cyclohexylpropyl, each of which is optionally substituted by fluorine, chlorine, bromine, cyano, methyl, ethyl, n- or i-propyl, or represents benzyl, phenylethyl, phenylpropyl, phenylbutyl, phenylethenyl, phenylpropenyl, phenylbutenyl, phenylethinyl, phenyl-propinyl or phenylbutinyl, each of which is optionally substituted by fluorine, chlorine, bromine, cyano, methyl, ethyl, n- or i-propyl, n-, s- or t-butyl, methoxy or ethoxy.

In certain embodiments, R₁ represents hydrogen, amino, or represents methyl, ethyl, n- or i-propyl, propenyl, butenyl, propinyl or butinyl, methoxy, ethoxy, n- or i-propoxy, propenyloxy or propinyloxy, each of which is optionally substituted by fluorine or chlorine, or represents methylamino, ethylamino, n- or i-propylamino, propenylamino or propinylamino, dimethylamino or diethylamino, or represents cyclopropyl or cyclopropylmethyl, each of which is optionally substituted by fluorine, chlorine, cyano or methyl.

In certain embodiments, R₂ represents methyl, ethyl, n- or i-propyl, n-, s- or t-butyl, propenyl, butenyl, propinyl, butinyl, methoxy, ethoxy, n- or i-propoxy, n-, s- or t-butoxy, propenyloxy, butenyloxy, propinyloxy, butinyloxy, methylthio, ethylthio, n- or i-propylthio, n-, s- or t-butylthio, propenylthio, butenylthio, propinylthio, butinylthio, methylamino, ethylamino, n- or i-propylamino, n-, s- or t-butylamino, propenylamino, butenylamino, propinylamino, butinylamino, dimethyl-lamino or diethylamino, each of which is optionally substituted by fluorine, chlorine, cyano, methoxy, ethoxy, methylthio or ethylthio, or represents cyclopropyl, cyclopropyloxy or cyclopropylmethyl, each of which is optionally substituted by fluorine, chlorine, cyano or methyl.

In certain embodiments, R₃ represents methyl, ethyl, n- or i-propyl, n-, s- or t-butyl, propenyl, butenyl, pentenyl, hexenyl, propinyl, butinyl, pentinyl or hexinyl, each of which is optionally substituted by fluorine, cyano, methoxy, ethoxy, n- or i-propoxy, methylthio, ethylthio, n- or i-propylthio, methylsulphinyl, ethylsulphinyl, methylsulphonyl, ethylsulphonyl, methylamino, ethylamino, n- or i-propylamino, dimethylamino or diethylamino, or represents cyclopropyl, cyclobutyl, cyclopentyl, cyclohexyl, cyclopropylmethyl, cyclobutylmethyl, cyclopentylmethyl, cyclohexylmethyl, cyclohexylethyl or cyclohexylpropyl, each of which is optionally substituted by fluorine, chlorine, bromine, cyano, methyl, ethyl, n- or i-propyl, or represents benzyl, phenylethyl, phenylpropyl, phenylbutyl, phenylethenyl, phenylpropenyl, phenylbutenyl, phenylethinyl, phenyl-propinyl or phenylbutinyl, each of which is optionally substituted by fluorine, chlorine, bromine, cyano, methyl, ethyl, n- or i-propyl, n-, s- or t-butyl, methoxy or ethoxy.

Non-limiting examples of individually compounds of the formula (I) to be used as components according to the invention in mixtures are:

4-amino-5-methyl-2-(1,1-dimethyl-ethyl-aminocarbonyl)-2,4-dihydro-3H-1,2,4-triazol-3-one, 4-amino-5-ethyl-2-(1,1-dimethyl-ethyl-aminocarbonyl)-2,4-dihydro-3H-1,2,4-triazol-3-one, 4-amino-5-n-propyl-2-(1,1-dimethyl-ethyl-aminocarbonyl)-2,4-dihydro-3H-1,2,4-triazol-3-one, 4-amino-5-i-propyl-2-(1,1-dimethyl-ethyl-aminocarbonyl)-2,4-dihydro-3H-1,2,4-triazol-3-one, 4-amino-5-methoxy-2-(1,1-dimethyl-ethyl-aminocarbonyl)-2,4-dihydro-3H-1,2,4-triazol-3-one, 4-amino-5-ethoxy-2-(1,1-dimethyl-ethyl-aminocarbonyl)-2,4-dihydro-3H-1,2,4-triazol-3-one, 4-amino-5-methyl-2-(2-fluoro-1,1-dimethyl-ethyl-aminocarbonyl)-2,4-dihydro-3H-1,2,4-triazol-3-one, 4-amino-5-ethyl-2-(2-fluoro-1,1-dimethyl-ethyl-aminocarbonyl)-2,4-dihydro-3H-1,2,4-triazol-3-one, 4-amino-5-n-propyl-2-(2-fluoro-1,1-dimethyl-ethyl-aminocarbonyl)-2,4-dihydro-3H-1,2,4-triazol-3-one, 4-amino-5-i-propyl-2-(2-fluoro-1,1-dimethyl-ethyl-aminocarbonyl)-2,4-dihydro-3H-1,2,4-triazol-3-one, 4-amino-5-methoxy-2-(2-fluoro-1,1-dimethyl-ethyl-aminocarbonyl)-2,4-dihydro-3H-1,2,4-triazol-3-one, 4-amino-5-ethoxy-2-(2-fluoro-1,1-dimethyl-ethyl-amino-carbonyl)-2,4-dihydro-3H-1,2,4-triazol-3-one, 4-amino-5-methyl-2-(2-chloro-1,1-dimethyl-ethyl-aminocarbonyl)-2,4-dihydro-3H-1,2,4-triazol-3-one, 4-amino-5-ethyl-2-(2-chloro-1,1-dimethyl-ethyl-aminocarbonyl)-2,4-dihydro-3H-1,2,4-triazol-3-one, 4-amino-5-n-propyl-2-(2-chloro-1,1-dimethyl-ethyl-aminocarbonyl)-2,4-dihydro-3H-1,2,4-triazol-3-one, 4-amino-5-i-propyl-2-(2-chloro-1,1-dimethyl-ethyl-amino-carbonyl)-2,4-dihydro-3H-1,2,4-triazol-3-one, 4-amino-5-methoxy-2-(2-chloro-1,1-dimethylethyl-aminocarbonyl)-2,4-dihydro-3H-1,2,4-triazol-3-one, 4-amino-5-ethoxy-2-(2-chloro-1,1-dimethyl-ethyl-aminocarbonyl)-2,4-dihydro-3H-1,2,4-triazol-3-one, 4-amino-5-i-propyl-2-i-propyl-aminocarbonyl-2,4-dihydro-3H-1,2,4-triazol-3-one, 4-amino-5-dimethylamino-2-(1,1-dimethyl-ethyl-aminocarbonyl)-2,4-dihydro-3H-1,2,4-triazol-3-one, 4-amino-5-dimethylamino-2-(2-fluoro-1,1-dimethyl-ethyl-aminocarbonyl)-2,4-dihydro-3H-1,2,4-triazol-3-one, 4-amino-5-dimethylamino-2-(2-chloro-1,1-dimethyl-ethyl-aminocarbonyl)-2,4-dihydro-3H-1,2,4-triazol-3-one and 4-methyl-5-methoxy-2-(1,1-dimethyl-ethyl-aminocarbonyl)-2,4-dihydro-3H-1,2,4-triazol-3-one.

The compound 4-amino-5-(1-methyl-ethyl)-2-(1,1-dimethyl-ethyl-aminocarbonyl)-2,4-dihydro-3H-1,2,4-triazol-3-one-in accordance with Chem. Abstracts also to be termed 4-amino-N-(1,1-dimethyl-ethyl)-4,5-dihydro-3-(1-methyl-ethyl)-5-oxo-1H-1,2,4-triazole-1-carboxamide (CAS-Reg. No.: 129909-90-6, Compound (1-1) of the use examples, proposed common name: “amicarbazone”)—is a component of the formula (I) in the mixture.

A family of compositions comprising a first compound and a second component, wherein said first compound is a compound of the formula (I)

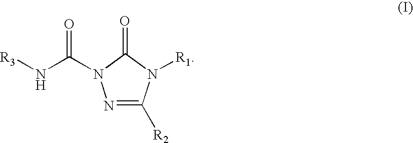

In certain embodiments, R₁ is an optionally substituted amino. In certain embodiments, R₁ is NH₂. In certain embodiments, R₂ is an optionally substituted alkyl. In certain embodiments, R₂ is i-propyl. In certain embodiments, R₃ is an optionally substituted alkyl. In certain embodiments, R₃ is t-butyl. In certain embodiments, the first compound is 4-amino-5-isopropyl-2-(tert-butyl-aminocarbonyl)-2,4-dihydro-3H-1,2,4-triazol-3-one (Amicarbazone).

In certain embodiments, the second component is 2-[(2-chlorophenyl)methyl]-4,4-dimethyl-3-isoxazolidinone and 3-cyclohexyl-6-dimethylamino-1-methyl-1,3,5-triazine-2,4(1H,3H)-dione. In certain embodiments, the second component is 4-methyl-2-chlorophenoxyacetic acid. In certain embodiments, the second component is one or more of N-ethyl-N′-(1-methylethyl)-6-(methylthio)-1,3,5-triazine-2,4-diamine, N-(3,4-dichlophenyl)-N,N-dimethyl urea, 5-cyclopropyl-4-(2-methylsulfonyl-4-trifluoromethylbenzoyl)isoxazole or 4-amino-6-tert-butyl-4,5-dihydro-3-methyltio-1,2,4-triazin-5-one.

Examples of a combination composition according to the invention include, but are not limited to:

Amicarbazone+clomazone+hexazinone; amicarbazone+MCPA+ethoxylated propoxylated fatty amines; amicarbazone+MCPA+polyether-polymethylsiloxane-copolymers; amicarbazone+ametryn+amtrazine; amicarbazone+diuron; amicarbazone+isoxaflutole; amicarbazone+metribuzin; amicarbazone+hexazinone; amicarbazone+hexazinone+diuron; and amicarbazone+ametrine+diuron; amicarbazone+tebuthiuron; and amicarbazone+propisochlor, amicarbazone+acetochlor, amicarbazone+metolachlor, amicarbazone+S-Metolachlor, amicarbazone+alachlor, amicarbazone+butachlor, amicarbazone+butenachlor, amicarbazone+delachlor, amicarbazone+diethatyl, amicarbazone+dimethachlor, amicarbazone+metazachlor, amicarbazone+pretilachlor, amicarbazone+propachlor, amicarbazone+prynachlor, amicarbazone+terbuchlor, amicarbazone+thenylchlor, and amicarbazone+xylachlor.

Optionally, a composition can include an adjuvant. An adjuvant may be used with the composition to enhance or improve herbicidal performance. Adjuvants may be added to the composition at the time of formulation, or by the applicator to the spray mix just prior to treatment. Adjuvants include surfactants, compatability agents, anti-foaming agents and spray colorants (dyes), and drift control agents. In certain embodiments, the adjuvant is an ethoxylated propoxylated fatty amine or a polyether-polymethylsiloxane-copolymer.

As disclosed herein, the compound combinations, in addition to being well tolerated by crops, have herbicidal activities and can be used in a variety of crops for selectively controlling weed. Non-limiting examples of crops include maize, wheat, sugar cane, barley, rice, citrus, palm trees, pineapple, cucurbits, beans, soybeans, agave, cassava, turf and pasture.

The compound combinations can also be used for controlling undesired vegetation in non-crop areas, e.g. fallow agricultural land. The term “non-crop area” used herein refers to areas where a crop, or any intentionally planted vegetation, is not grown. The term “fallow agricultural land” used herein refers to a piece of land where no crop or pasture is growing. A fallow agricultural land that is not used for crops, may be left unused in order to restore its natural fertility.

In various embodiments, the herbicidal activity of a composition according to the invention exceeds the total of the activities of the individual active compounds. If there are two active compounds, the activity will be greater than the same of the single active compound alone. Thus, in various embodiments, herbicidal compositions include compositions synergistic for control of one or more weeds.

The compositions of the invention have been found to be active herbicides in possessing herbicidal activity against one or more species of weeds. In the broadest sense, the term “weed” refers to plants which grow in locations in which they are not desired. In other words, a weed is a plant in which in the context of a crop is undesirable due to competition for water, nutrients, sunlight, soil, etc.

As used herein the term “herbicide” refers to a compound which adversely control, or modifies (e.g. limits or reduces) the growth of plants, particularly of undesirable plants. A “herbicidally effective amount” is meant an amount of compound which causes an adverse effect on the growth of plants, such as weeds. The herbicide can affect pre- or post-emergent growth or both.

The term “plants” is meant to include germinant seeds, emerging seedlings, and established vegetation, including roots and above-ground portions (for example, leaves, stalks, flowers, fruits, etc.) Such adverse modifying and controlling effects may include all deviations from natural plant development, including killing the weed.

The compositions of the invention can be used, for example, in control of one or more of following plants (weeds):

Monocotyledonous weeds include the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagittaria, Scirpus, Setaria, Sorghum. Dicotyledonous weeds include the genera: Abutilon, Amaranthus, Ambrosia, Anoda, Anthemis, Aphanes, Atriplex, Bellis, Bidens, Capsella, Carduus, Cassia, Centaurea, Chenopodium, Cirsium, Convolvulus, Croton, Datura, Desmodium, Emex, Erysimum, Euphorbia, Galeopsis, Galinsoga, Galium, Hibiscus, Ipomoea, Kochia, Lamium, Lepidium, Lindernia, Matricaria, Mentha, Mercurialis, Merremia, Momordica, Mullugo, Myosotis, Papaver, Pharbitis, Plantago, Polygonum, Portulaca, Ranunculus, Raphanus, Ricinus, Rorippa, Rotala, Rumex, Salsola, Senecio, Sesbania, Sida, Sinapis, Solanum, Sonchus, Sphenoclea, Stellaria, Stizolobium, Taraxacum, Thlaspi, Trifolium, Urtica, Veronica, Viola, Xanthium.

The use of the active compound combinations according to the invention is in no way restricted to these genera, but also extends in the same manner to other plants.

Depending on the concentration, the herbicidal compositions are suitable for selective weed control in crops, for example, cereals, rice, maize, sorghum, sugar cane, cotton, canola, soya, turf, barley, potato, sweet potato, sunflower, rye, oats, wheat, corn, soybean, sugar beet, safflower, alfalfa, cassava, cucurbits, pineapple and pastures.

Specific weed species encountered in corn include, but not limited to, Ixophorus unisetus, Amaranthus hybridu, Ipomoea purpurea, and Sicyos angulata.

Specific weed species encountered in sugar cane include, but not limited to, Acalypha sp., Boerhavia erecta, Trianthema portulacastrum, Amaranthus hybridus, and Amaranthus lividus.

In particular embodiments, a synergistic effect of the compound combinations according to the invention is present. As used herein, the term “synergism” means that the herbicidal action of the active compound combination exceeds the action of the active compounds when applied individually on a given weed, either pre- or post-emergent.

The ratios by weight of an active compound (e.g. group a and group b) in the active compound combinations can be varied within relatively wide ranges. In general, 0.001 to 1000 parts by weight, 0.02 to 500 parts by weight, 0.05 to 100 by weight, 0.01 to 100 parts by weight, or 0.1 to 10 parts by weight of one or more active compound(s) of the second component (group b) are used per part by weight of the first compound (group a).

In the treatment of crops, in general, the application rate is from 0.01 kg/ha to 5.00 kg/ha or from 0.03 kg/ha to 3.00 kg/ha of the first compound, and from 0.5 kg/ha to 10.00 kg/ha or from 0.05 kg/ha to 5.00 kg/ha of the second component.

The herbicidal compositions can be in customary formulations, such as solutions, emulsions, wettable powders, suspensions, powders, dusts, pastes, soluble powders, granules, suspo-emulsion concentrates, emulsifiable concentrate, oil spray, aerosol, natural and synthetic materials impregnated with active compound, and very fine capsules in polymeric substances. In certain embodiments, the compositions is in a form of an emulsifiable concentrate, wettable powder, granule, dust, oil spray or aerosol.

These formulations can be produced, for example by mixing the active compounds with extenders, that is liquid solvents and/or solid carriers, optionally with the use of surface-active agents, such as emulsifying agents and/or dispersing agents and/or foam-forming agents.

In the case of the use of water as an extender, organic solvents can, for example, also be used as auxiliary solvents. Liquid solvents include aromatics, such as xylene, toluene or alkylnaphthalenes, chlorinated aromatics and chlorinated aliphatic hydrocarbons, such as chlorobenzenes, chloroethylenes or methylene chloride, ali-phatic hydrocarbons, such as cyclohexane or paraffins, for example petroleum fractions, mineral and vegetable oils, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, as well as water.

As solid carriers there are suitable, for example, ammonium salts and ground natural minerals, such as kaolins, clays, talc, chalk, quartz, attapulgite, mont-morillonite or diatomaceous earth, and ground synthetic minerals, such as finely divided silica, alumina and silicates, as solid carriers for granules there are suitable: for example crushed and fractionated natural rocks such as calcite, marble, pumice, sepiolite and dolomite, as well as synthetic granules of inorganic and organic meals, and granules of organic material such as sawdust, coconut shells, maize cobs and tobacco stalks; as emulsifying and/or foam-forming agents there are suitable: for example nonionic and anionic emulsifiers, such as polyoxyethylene fatty acid esters, poly-oxyethylene fatty alcohol ethers, for example alkylaryl polyglycol ethers, alkylsulphonates, alkyl sulphates, aryl-sulphonates as well as protein hydrolysates; as dispersing agents there are suitable: for example lignin-sulphite waste liquors and methylcellulose.

Adhesives such as carboxymethylcellulose and natural and synthetic polymers in the form of powders, granules or latexes, such as gum arabic, polyvinyl alcohol and polyvinyl acetate, as well as natural phospholipids, such as cephalins and lecithins, and synthetic phospholipids, can be used in the formulations. Further additives may be mineral and vegetable oils.

Colourants can also included in the formulations. Non-limiting examples are inorganic pigments, such as iron oxide, titanium oxide and Prussian Blue, and organic dyestuffs, such as alizarin dyestuffs, azo dye-stuffs and metal phthalocyanine dyestuffs, and trace nutrients such as salts of iron, manganese, boron, copper, cobalt, molybdenum and zinc.

The formulations in general comprise between 0.1 and 95 percent by weight, or between 0.5 and 90 percent by weight, of each of the active compounds from group a (or the first compound) and group b (or the second component).

Herbicidal compositions according to the invention can be applied in the form of ready mixes. Herbicidal compositions can also be formulated individually and mixed upon use, i.e. applied in the form of tank mixes.

Herbicidal compositions can be used as such or in the form of their formulations, and furthermore also as mixtures with other known herbicides, ready mixes or tank mixes. They may also be mixed with other known active compounds, such as fungicides, insecticides, acaricides, nematicides, bird repellents, growth substances, plant nutrients and agents which improve soil structure. For particular application purposes, in particular when applied post-emergence, formulations such as mineral or vegetable oils which are tolerated by plants (for example the commercial product “Oleo DuPont 11E”) or ammonium salts such as, for example, ammonium sulphate or ammonium thiocyanate, as further additives can be included.

Herbicidal compositions can be used as such, in the form of their formulations or in the forms prepared therefrom by dilution of a concentrated form, such as ready-to-use or concentrated solutions, suspensions, emulsions, powders, pastes and granules. They are used in the customary manner, for example by watering, spraying, atomizing, dusting or scattering.

Herbicidal compositions according to the invention can be applied before and after the plants have emerged, that is to say pre-emergence and post-emergence. They can also be incorporated into the soil before, during or after sowing seeds of a crop.

The invention also provides methods for controlling undesirable plants or vegetation. In one embodiment, a method includes applying to a crop where control of such vegetation is desired, an herbicidally effective amount of a composition. Such methods include a composition of the invention, optionally together with an adjuvant, an inert diluent or a carrier suitable for use with an herbicide.

The invention also provides methods for selective control of weeds. In one embodiment, a method includes contacting a composition of the invention onto a crop plant in need of weed control or at risk of undesirable weeds, in an amount effective to provide weed control in the crop.

Herbicidal activity of the compound combinations can be seen from the examples which follow. While the individual active compounds show less activity with regard to herbicidal activity, certain combinations have a herbicidal activity which exceeds a simple sum of the activity of the individual active compounds.

Activity for a given combination of two active compounds can be calculated as follows (cf. COLBY. S. R.: “Calculating synergistic and antagonistic responses of herbicide combinations”. Weeds 15, Pages 20-22. 1967):

### If:

X=% damage by herbicide A (active compound of group a) at an application rate of p kg/ha,

Y=% damage by herbicide B (active compound of group b) at an application rate of q kg/ha,

E=the expected % damage of herbicides A+B at an application rate of p+q kg/ha, then

E=X+Y−(X*Y/100).

Similarly, according to Colby, the activity for a given combination of three active compounds can be calculated as follows (cf. COLBY. S. R.: “Calculating synergistic and antagonistic responses of herbicide combinations”. Weeds 15, Pages 20-22. 1967):

### If:

X=% damage by herbicide A (active compound of group a) at an application rate of p kg/ha,

Y=% damage by herbicide B1 (a first active compound of group b) at an application rate of q kg/ha,

Y=% damage by herbicide B2 (a second active compound of group b) at an application rate of r kg/ha,

E=the expected % damage of herbicides A+B1+B2 at an application rate of p+q+r kg/ha, then

E=X+Y+Z−(X*Y+X*Z+Y*Z)/100)+X*Y*Z/10,000.

If the actual damage exceeds the calculated value (E), the combination is considered to have synergistic effect activity.

It can be seen from the use examples herein below that the found herbicidal action of the active compound combinations according to the invention exceeds the calculated value, that is to say that the new active compound combinations have a synergistic effect.

Unless otherwise defined, all technical and scientific terms used herein have the same meaning as commonly understood by one of ordinary skill in the art to which this invention belongs. Although methods and materials similar or equivalent to those described herein can be used in the practice or testing of the invention, suitable methods and materials are described herein.

All applications, publications, patents and other references, citations cited herein are incorporated by reference in their entirety. In case of conflict, the specification, including definitions, will control.

As used herein, the singular forms “a”, “and,” and “the” include plural referents unless the context clearly indicates otherwise.

As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth.

The invention is generally disclosed herein using affirmative language to describe the numerous embodiments. The invention also specifically includes embodiments in which particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein.

A number of embodiments of the invention have been described. Nevertheless, it will be understood that various modifications may be made without departing from the spirit and scope of the invention. Accordingly, the following examples are intended to illustrate but not limit the scope of invention described in the claims.

### EXAMPLES

### Herbicidal Activity Studies

### Example 1

### Evaluation of Synergistic Action Between Amicarbazone and Propisochloron Digitaria Ciliaris

The herbicide study was conducted at Aburahi Agricultural Research Trial Grass house in Shiga Prefecture, Japan. Various mixtures of Dinamic (Amicarbazone 70 DF) and Proponit (Propisochlor 720 EC) was applied pre-emergence using foliar application by manual sprayer in this study. The mixture was diluted in water immediately prior to application, and applied at the concentration in Table 1. The application rate was 1000 L water/ha. Digitaria ciliaris was grown in square plastic pots (10 cm×10 cm) and replicated three times.

The herbicidal effect was observed by comparing the extent of Digitaria ciliaris treated with the compounds against that occurring in similar non-treated control. Herbicidal effect was visually assessed and recorded at 5, 8, 14, 21 and 28 days after treatment (DAT). Damage by the herbicidal compositions was evaluated with reference to a scale of 0% to 100% in comparison with untreated control. 0% means no damage and 100% means complete destruction of the plants.

The herbicide effect of amicarbazone, in particular, at 50 g/ha and 100 g/ha, was small on Disitaria ciliaris at the one-leaf stage. Similarly, the herbicide effect of propisochlor was less apparent on Disitaria ciliaris at the one-leaf stage, for example, the weeding effect index was less than 50% at 5 DAT observation at all tested dose rate. Surprisingly, treatments with the herbicidal mixtures significantly increase the % damage on the weed. Assessment of the synergistic effect was evaluated using the Colby method. The herbicidal mixtures (amicarbazone+propisochlor) exert a greater herbicidal action than expected according to Colby on the basis of the observed effects of the individual components when used alone. Therefore, a synergistic effect between amicarbazone and propisochlor was confirmed on Disitaria ciliaris.

TABLE 1
Pre-emergence treatment effects on Digitaria ciliaris (one
leaf-stage of weeds) with various mixtures of amicarbazone and
propisochlor, expressed as percentage control

| | | | Propisochlor (Rate/ha) | | | |
|---|---|---|---|---|---|---|
| | | DAT | 0 g | 50 g | 100 g | 200 g |
| Amicarbazone (Rate/ha) | 0 g | 5 | 0 | 28 | 42 | 44 |
| | | 8 | 0 | 70 | 78 | 80 |
| | | 14 | 0 | 76 | 86 | 90 |
| | | 21 | 0 | 88 | 94 | 98 |
| | | 28 | 0 | 82 | 92 | 98 |
| | 50 g | 5 | 24 | 70 | 68 | 84 |
| | | | | (45.3) | (55.9) | (57.4) |
| | | 8 | 38 | 78 | 84 | 86 |
| | | | | (81.4) | (86.4) | (87.6) |
| | | 14 | 34 | 88 | 94 | 94 |
| | | | | (84.2) | (90.8) | (93.4) |
| | | 21 | 34 | 94 | 98 | 98 |
| | | | | (92.1) | (96.0) | (98.7) |
| | | 28 | 26 | 96 | 100 | 100 |
| | | | | (86.7) | (94.1) | (98.5) |
| | 100 g | 5 | 70 | 94 | 94 | 96 |
| | | | | (78.4) | (82.6 | (83.2) |
| | | 8 | 78 | 98 | 98 | 98 |
| | | | | (93.4) | (95.2) | (95.6) |
| | | 14 | 82 | 98 | 100 | 100 |
| | | | | (95.7) | (97.5) | (98.2) |
| | | 21 | 74 | 100 | 100 | 100 |
| | | | | (96.9) | (98.4) | (99.5) |
| | | 28 | 66 | 100 | 100 | 100 |
| | | | | (93.9) | (97.3) | (99.3) |
| | 200 g | 5 | 92 | 100 | 100 | 100 |
| | | | | (94.2) | (95.4) | (95.5) |
| | | 8 | 96 | 100 | 100 | 100 |
| | | | | (98.8) | (99.1) | (99.2) |
| | | 14 | 98 | 100 | 100 | 100 |
| | | | | (99.5) | (99.7) | (99.8) |
| | | 21 | 86 | 100 | 100 | 100 |
| | | | | (98.3) | (99.2) | (99.7) |
| | | 28 | 86 | 100 | 100 | 100 |
| | | | | (97.5) | (98.9) | (99.7) |

( ) indicates the calculated expected percent damage according to Colby method E, wherein E = a + b (100 − a)/100
A: Herbicidal effect of Propisochlor as single application
B: Herbicidal effect of Amicarbazone as single application
Herbicidal effect index: 0 (No efficacy)-100 (Complete kill)

### Example 2

### Evaluation of Synergistic Action Between Amicarbazone and Clomazone/Hexazinone on Cyperus Esculentus

Dinamic (amicarbazone) and Discover (clomazone 400 g/kg+hexazinone 100 g/kg) alone or in combination were applied pre-emergence in this study. The formulations for Dinamic and Discover were 700 g active ingredient a.i./kg and 500 g active ingredient a.i./kg respectively.

The herbicidal effect was observed by comparing the extent of Cyperus esculentus treated with the compounds against that occurring in similar non-treated control. Herbicidal effect was visually assessed and recorded at 27, 43, 46, 60, 63, 77, 83, 97 and 124 days after treatment (DAT). Damage by the herbicidal compositions was evaluated with reference to a scale of 0% to 100% in comparison with untreated control. 0% means no damage and 100% means complete destruction of the plants.

The results in Table 2 indicate synergistic effects between amicarbazone and the clomazone/hexazinone partner. Assessment of the synergistic effect was evaluated using the Colby method. The theoretical herbicidal effect index were calculated based on Colby and the values were indicated in bracket ( ) in Table 2. The herbicidal mixtures (amicarbazone+(clomazone/hexazinone)) exert a greater herbicidal action than expected according to Colby on the basis of the observed effects of the individual components when used alone. In both Trials 1 and 2, the observed herbicidal effects are greater than the theoretical herbicidal effects at DAT 77 and DAT 124 respectively, therefore, there exist synergistic effects between amicarbazone and the clomazone/hexazinone partner on Cyperus esculentus. The underlined values in the table indicate that the observed weed killing is greater than calculated from the Colby formula and therefore indicates a synergistic weed killing effect or activity.

TABLE 2
Pre-emergence treatment effects on Cyperus esculentus, expressed as
percentage control

| | Application | | | | | | | | | |
|---|---|---|---|---|---|---|---|---|---|---|
| | Rate | Days After Treatment (DAT) | | | | | | | | |
| Active Ingredient(s) | (kg/ha) | 27 | 43 | 46 | 60 | 63 | 77 | 83 | 97 | 124 |
| Trial 1 | | | | | | | | | | |
| Amicarbazone | 1.5 | | 40 | | | 62 | 65 | | | |
| Clomazone/Hexazinone | 2.0 | | 0 | | | 0 | 0 | | | |
| Amicarbazone + | 1.5 + 2.0 | | 83 | | | 94 | 96 | | | |
| (Clomazone/Hexazinone) | | | | | | | (65) | | | |
| Trial 2 | | | | | | | | | | |
| Amicarbazone | 1.5 | 37 | | 53 | 57 | | | 68 | 53 | 23 |
| Clomazone/Hexazinone | 2.0 | 45 | | 40 | 17 | | | 17 | 5 | 0 |
| Amicarbazone + | 1.5 + 2.0 | 22 | | 86 | 82 | | | 84 | 85 | 77 |
| (Clomazone/Hexazinone) | | | | | | | | | | (23) |

( ) indicates the calculated expected percent damage according to Colby method E, wherein E = a + b (100 − a)/100
A: Herbicidal effect of Clomazone/Hexazinone as single application
B: Herbicidal effect of Amicarbazone as single application
Herbicidal effect index: 0 (No efficacy)-100 (Complete kill)

### Example 3

### Evaluation of Synergistic Action Between Amicarbazone and Other Herbicides on Cyperus Rotundus

Dinamic (amicarbazone) in combination of various herbicides listed in Table A were tested for herbicidal activity.

TABLE A
Herbicides used in combination of amicarbazone

| Name | Active Ingredients | Source |
|---|---|---|
| Volcano-blend | Ethoxylated propoxylated fatty | Volcano Agroscience |
| (adjuvant) | amines 1000 g/L | |
| Break Thru | Polyether-polymethylsiloxane- | Goldschmidt Chemical |
| (adjuvant) | copolymer 100% | Corporation |
| MCPA | 4-Methyl-2-chlorophenoxyacetic | Volcano Agroscience |
| | acid | |

The herbicidal effect was observed by comparing the extent of Cyperus esculentus treated with the compounds against that occurring in similar non-treated control. Herbicidal effect was visually assessed and recorded at 4, 8, 18 and 34 days after treatment (DAT). Damage by the herbicidal compositions was evaluated with reference to a scale of 0% to 100% in comparison with untreated control. 0% means no damage and 100% means complete destruction of the plants.

Table 3 provides post-emergence treatment effects on Cyperus esculentus between amicarbazone and 4-methyl-2-chlorophenoxyacetic acid with an adjuvant.

TABLE 3
Post-emergence treatment effects on Cyperus esculentus, expressed as percentage
(by volume) control

| | | Days After | | | |
|---|---|---|---|---|---|
| | Application Rate | Treatment (DAT) | | | |
| Active Ingredient(s) | (kg/ha or L/ha) | 4 | 8 | 18 | 34 |
| Amicarbazone + Volcano-Blend (adjuvant) | 1.0 + 0.2% | 0 | 5 | 0 | 0 |
| Amicarbazone + MCPA + Volcano-Blend | 1.0 + 3.5 + 0.2% | 0 | 50 | 70 | 0 |
| (adjuvant) | | | | | |
| Amicarbazone + Break Thru (adjuvant) | 1.0 + 0.1% | 0 | 5 | 0 | 0 |
| Amicarbazone + MCPA + Break Thru (adjuvant) | 1.0 + 3.5 + 0.1% | 0 | 50 | 75 | 50 |

### Example 4

### Evaluation of Synergistic Action Between Amicarbazone and Other Herbicides on Cyperus Rotundus

Dinamic (amicarbazone) in combination of various herbicides listed in Table B were tested for herbicidal activity.

TABLE B
Herbicides used in combination of amicarbazone

| Name | Active Ingredients | Source |
|---|---|---|
| Gesapax | Ametryn: N-ethyl-N′-(1- | Syngenta |
| | methylethyl)-6-(methylthio)-1,3,5- | |
| | triazine-2,4-diamine, 500 g/L | |
| Karmex | Diuron: N-(3,4-dichlophenyl)-N,N- | Goldschmidt Chemical |
| | dimethyl urea, 800 g/kg | Corporation DuPont |
| | | (in Brazil) |
| Provence | Isoxaflutole: 5-cyclopropyl-4- | Bayer Group |
| | isoxazolyl)[2-(methylsulfonyl)-4- | |
| | (trifluoromethyl)phenyl]methanone, | |
| | 750 g/kg | |
| Sencor | Metribuzin: 4-amino-6-(1,1- | Bayer Group |
| | dimethylethyl)-3-(methylthio)-1,2,4- | |
| | triazin-5(4H)-one, 480 g/kg | |

The herbicidal effect was observed by comparing the extent of Euphorbia heterophylla (EPHHL) treated with the compounds against that occurring in similar non-treated control. Herbicidal effect was visually assessed and recorded at 14, 23, 36, 49, 65 and 77 days after treatment (DAT). Damage by the herbicidal compositions was evaluated with reference to a scale of 0% to 100% in comparison with untreated control. 0% means no damage and 100% means complete destruction of the plants.

The results in Table 4 indicate synergistic effects in the herbicidal treatments with (Amicarbazone+Karmex) mixtures and (Amicarbazone+Sencor) mixtures on Euphorbia heterophylla. Assessment of the synergistic effect was evaluated using the Colby method. The theoretical herbicidal effect index were calculated based on Colby and the values were indicated in bracket ( ) in Table 4. Both of the herbicidal mixtures (amicarbazone+Karmex) and (amicarbazone+Sencor) exert a greater herbicidal action than expected according to Colby on the basis of the observed effects of the individual components when used alone. The observed herbicidal effects are greater than the theoretical herbicidal effects at DAT 49, 65 and 77, therefore, there exist synergistic effects. On the other hand, antagonic effects were observed in the herbicidal treatments with (Amicarbazone+Gesapax) mixtures and (Amicarbazone+Provence) mixtures on Euphorbia heterophylla, as the observed herbicidal effects were smaller than the theoretical herbicidal effects at any of the DAT tested (i.e. DAT=14, 23, 36, 49, 65 and 77). The underlined values in the table indicate that the observed weed killing is greater than calculated from the Colby formula and therefore indicates a synergistic weed killing effect or activity.

TABLE 4
Pre-emergence treatment effects on Euphorbia heterophylla, expressed as
percentage control

| | Application Rate | Days After Treatment (DAT) | | | | | |
|---|---|---|---|---|---|---|---|
| Active Ingredient(s) | (kg/ha or L/ha) | 14 | 23 | 36 | 49 | 65 | 77 |
| Amicarbazone | 1.50 | 98 | 98 | 96 | 96 | 96 | 90 |
| Amicarbazone | 1.00 | 96 | 96 | 96 | 79 | 79 | 75 |
| Amicarbazone + Gesapax | 1.00 + 3.00 | 96 | 96 | 96 | 86 | 86 | 85 |
| | | (100) | (99) | (99) | (89) | (88) | (86) |
| Gesapax | 3.00 | 96 | 84 | 80 | 47 | 45 | 45 |
| Gesapax | 5.00 | 96 | 72 | 66 | 50 | 47 | 47 |
| Amicarbazone + Karmex | 1.00 + 3.00 | 96 | 94 | 96 | 90 | 90 | 90 |
| | | (100) | (98) | (98) | (86) | (84) | (81) |
| Karmex | 3.00 | 96 | 60 | 60 | 35 | 23 | 23 |
| Karmex | 5.00 | 98 | 80 | 80 | 50 | 50 | 35 |
| Amicarbazone + Provence | 1.00 + 0.15 | 96 | 96 | 96 | 82 | 80 | 82 |
| | | (100) | (98) | (98) | (84) | (88) | (85) |
| Provence | 0.15 | 90 | 60 | 60 | 45 | 42 | 40 |
| Provence | 0.20 | 96 | 82 | 80 | 80 | 66 | 65 |
| Amicarbazone + Sencor | 1.00 + 2.00 | 96 | 96 | 96 | 96 | 90 | 90 |
| | | (100) | (99) | (99) | (88) | (85) | (85) |
| Sencor | 2.00 | 96 | 85 | 75 | 41 | 40 | 40 |
| Sencor | 3.50 | 96 | 85 | 85 | 56 | 50 | 50 |

( ) indicates the calculated expected percent damage according to Colby method E, wherein E = a + b (100 − a)/100
A: Herbicidal effect of the second active ingredients (i.e. Gesapax, Karmex, Provence or Sencor) as single application
B: Herbicidal effect of Amicarbazone as single application
Herbicidal effect index: 0 (No efficacy)-100 (Complete kill)

The herbicidal effect was observed by comparing the extent of Ipomoea gradifolia (IAOGR) treated with the compounds against that occurring in similar non-treated control. Herbicidal effect was visually assessed and recorded at 14, 23, 36, 49, 65 and 77 days after treatment (DAT). Damage by the herbicidal compositions was evaluated with reference to a scale of 0% to 100% in comparison with untreated control. 0% means no damage and 100% means complete destruction of the plants. The results of the observed herbicidal effect and the theoretical herbicidal effected were shown in Table 5. Assessment of the synergistic effect was evaluated using the Colby method. The theoretical herbicidal effect index were calculated based on Colby and the values were indicated in bracket ( ). Most of the observed herbicidal effects were smaller than the theoretical herbicidal effects in most of the tested results, which indicate antagonic effects. Some of the observed herbicidal effects were the same as the theoretical hervicidal effects, which indicate additive effects. The underlined values in the table indicate that the observed weed killing is greater than calculated from the Colby formula and therefore indicates a synergistic weed killing effect or activity.

TABLE 5
Pre-emergence treatment effects on Ipomoea gradifolia, expressed as percentage control

| | Application Rate | Days After Treatment (DAT) | | | | | |
|---|---|---|---|---|---|---|---|
| Active Ingredient(s) | (kg/ha or L/ha) | 14 | 23 | 36 | 49 | 65 | 77 |
| Amicarbazone | 1.50 | 98 | 98 | 98 | 98 | 96 | 97 |
| Amicarbazone | 1.00 | 100 | 98 | 96 | 96 | 93 | 93 |
| Amicarbazone + Gesapax | 1.00 + 3.00 | 100 | 98 | 96 | 96 | 98 | 96 |
| | | (100) | (100) | (99) | (98) | (96) | (96) |
| Gesapax | 3.00 | 99 | 87 | 85 | 60 | 47 | 45 |
| Gesapax | 5.00 | 100 | 96 | 96 | 60 | 60 | 58 |
| Amicarbazone + Karmex | 1.00 + 3.00 | 99 | 96 | 96 | 97 | 94 | 96 |
| | | (100) | (100) | (100) | (100) | (98) | (98) |
| Karmex | 3.00 | 99 | 97 | 96 | 77 | 70 | 70 |
| Karmex | 5.00 | 98 | 96 | 96 | 79 | 70 | 60 |
| Amicarbazone + Provence | 1.00 + 0.15 | 100 | 96 | 96 | 98 | 93 | 96 |
| | | (100) | (99) | (98) | (98) | (96) | (96) |
| Provence | 0.15 | 90 | 67 | 60 | 47 | 45 | 45 |
| Provence | 0.20 | 96 | 94 | 90 | 90 | 64 | 64 |
| Amicarbazone + Sencor | 1.00 + 2.00 | 100 | 96 | 96 | 96 | 96 | 96 |
| | | (100) | (100) | (100) | (100) | (99) | (98) |
| Sencor | 2.00 | 100 | 96 | 96 | 96 | 84 | 70 |
| Sencor | 3.50 | 100 | 96 | 96 | 96 | 80 | 67 |

( ) indicates the calculated expected percent damage according to Colby method E, wherein E = a + b (100 − a)/100
A: Herbicidal effect of the second active ingredients (i.e. Gesapax, Karmex, Provence or Sencor) as single application
B: Herbicidal effect of Amicarbazone as single application
Herbicidal effect index: 0 (No efficacy)-100 (Complete kill)

The herbicidal effect was observed by comparing the extent of Croton glandulosus (CROTON) treated with the compounds against that occurring in similar non-treated control. Herbicidal effect was visually assessed and recorded at 14, 23, 36, 49, 65 and 77 days after treatment (DAT). Damage by the herbicidal compositions was evaluated with reference to a scale of 0% to 100% in comparison with untreated control. 0% means no damage and 100% means complete destruction of the plants. The results of the observed herbicidal effect and the theoretical herbicidal effected were shown in Table 6. Assessment of the synergistic effect was evaluated using the Colby method. The theoretical herbicidal effect index were calculated based on Colby and the values were indicated in bracket ( ). Some of the observed herbicidal effects were the same as the theoretical hervicidal effects, which indicate additive effects. The underlined values in the table indicate that the observed weed killing is greater than calculated from the Colby formula and therefore indicates a synergistic weed killing effect or activity.

TABLE 6
Pre-emergence treatment effects on Croton glandulosus, expressed
as percentage control

| | Application Rate | Days After Treatment (DAT) | | | | | |
|---|---|---|---|---|---|---|---|
| Active Ingredient(s) | (kg/ha or L/ha) | 14 | 23 | 36 | 49 | 65 | 77 |
| Amicarbazone | 1.50 | 100 | 99 | 99 | 99 | 99 | 99 |
| Amicarbazone | 1.00 | 100 | 99 | 99 | 95 | 99 | 99 |
| Amicarbazone + Gesapax | 1.00 + 3.00 | 100 | 99 | 99 | 99 | 99 | 99 |
| | | (100) | (99) | (99) | (97) | (99) | (99) |
| Gesapax | 3.00 | 96 | 60 | 60 | 40 | 40 | 40 |
| Gesapax | 5.00 | 100 | 84 | 80 | 62 | 62 | 62 |
| Amicarbazone + Karmex | 1.00 + 3.00 | 100 | 99 | 99 | 99 | 99 | 99 |
| | | (100) | (99) | (99) | (99) | (99) | (99) |
| Karmex | 3.00 | 100 | 92 | 90 | 87 | 87 | 80 |
| Karmex | 5.00 | 100 | 92 | 92 | 88 | 88 | 75 |
| Amicarbazone + Provence | 1.00 + 0.15 | 100 | 99 | 99 | 99 | 93 | 90 |
| | | (100) | (99) | (99) | (97) | (99) | (99) |
| Provence | 0.15 | 100 | 65 | 65 | 42 | 42 | 40 |
| Provence | 0.20 | 99 | 90 | 90 | 60 | 60 | 60 |
| Amicarbazone + Sencor | 1.00 + 2.00 | 100 | 99 | 99 | 99 | 99 | 99 |
| | | (100) | (99) | (99) | (99) | (99) | (99) |
| Sencor | 2.00 | 100 | 96 | 96 | 98 | 99 | 98 |
| Sencor | 3.50 | 100 | 96 | 96 | 96 | 96 | 96 |

( ) indicates the calculated expected percent damage according to Colby method E, wherein E = a + b (100 − a)/100
A: Herbicidal effect of the second active ingredients (i.e. Gesapax, Karmex, Provence or Sencor) as single application
B: Herbicidal effect of Amicarbazone as single application
Herbicidal effect index: 0 (No efficacy)-100 (Complete kill)

What is claimed is:

1. A composition comprising a synergistic effective amount of a combination of a first compound and a second component, wherein said first compound is a compound of the formula (I) 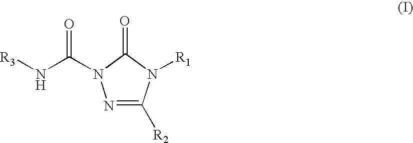
wherein:
R₁ is selected from the group consisting of hydrogen, hydroxyl, amino, or in each case optionally substituted alkyl, alkenyl, alkinyl, alkoxy, alkenyloxy, alkinyloxy, alkylamino, alkenylamino, alkenylamino, alkylideneamino, dialkylamino, cycloalkyl, cycloalkylalkyl, aryl and arylalkyl, any of which may be optionally substituted;
R₂ is selected from the group consisting of alkyl, alkenyl, alkinyl, alkoxy, alkenyloxy, alkinyloxy, alkylthio, alkenylthio, alkinylthio, alkylamino, alkenylamino, alkinylamino, dialkylamino, cycloalkyl, cycloalkyloxy, cycloalkylalkyl, aryl, aryloxy, arylthio, arylamino and arylalkyl, any of which may be optionally substituted;
R₃ is selected from the group consisting of alkyl, alkenyl, alkinyl, cycloalkyl, cycloalkylalkyl, arylalkyl, arylalkenyl and arylalkinyl, any of which may be optionally substituted; and
said second component is selected from 2-[(2-chlorophenyl)methyl]-4,4-dimethyl-3-isoxazolidinone, 3-cyclohexyl-6-dimethylamino-1-methyl-1,3,5-triazine-2,4(1H,3H)-dione, 4-methyl-2-chlorophenoxyacetic acid, 2-chloro-4-(ethylamine)-6-(isopropylamine)-s-triazine, 2-chloro-N-(2-ethyl-6-methylphenyl)-N-[(1-methylethoxy)methyl]acetamide, an herbicide of the chloroacetamide class, and mixtures thereof.

2. The composition according to claim 1, wherein the herbicide of the chloroacetamide class is selected from 2-chloro-N-(2-ethyl-6-methylphenyl)-N-[(1-methylethoxy)methyl]acetamide, 2-chloro-N-ethoxymethyl-6′-ethylacet-o-toluidide, 2-chloro-N-(2-ethyl-6-methylphenyl)-N-(2-methoxy-1-methylethyl)acetamide, 2-chloro-N-(2-ethyl-6-methylphenyl)-N-[(1S)-2-methoxy-1-methylethyl]acetamide, 2-chloro-N-(2,6-diethylphenyl)-N-(methoxymethyl)acetamide, and N-(butoxymethyl)-2-chloro-N-(2,6-diethylphenyl)acetamide, N-[[(2Z)-2-butenyloxy]methyl]-2-chloro-N-(2,6-diethylphenyl)acetamide, 2-chloro-N-(2,6-dimethylphenyl)-N-[(2-methylpropoxy)methyl]acetamide, N-(chloroacetyl)-N-(2,6-diethylphenyl)glycine, 2-chloro-N-(2,6-dimethylphenyl)-N-(2-methoxyethyl)acetamide, 2-chloro-N-(2,6-dimethylphenyl)-N-(1H-pyrazol-1-ylmethyl)acetamide, 2-chloro-N-(2,6-diethylphenyl)-N-(2-propoxyethyl)acetamide, 2-chloro-N-(1-methylethyl)-N-phenylacetamide, 2-chloro-N-(1-methyl-2-propynyl)-N-phenylacetamide, N-(butoxymethyl)-2-chloro-N-[2-(1,1-dimethylethyl)-6-methylphenyl]acetamide, 2-chloro-N-(2,6-dimethylphenyl)-N-[(3-methoxy-2-thienyl)methyl]acetamide, and 2-chloro-N-(2,3-dimethylphenyl)-N-(1-methylethyl)acetamide.

3. The composition according to claim 1, wherein R₁ is an optionally substituted amino.

4. The composition according to claim 1, wherein R₁ is NH₂.

5. The composition according to claim 1, wherein R₂ is an optionally substituted alkyl.

6. The composition according to claim 1, wherein R₂ is i-propyl.

7. The composition according to claim 1, wherein R₃ is an optionally substituted alkyl.

8. The composition according to claim 1, wherein R₃ is t-butyl.

9. The composition according to claim 1, wherein the first compound is 4-amino-5-isopropyl-2-(tert-butyl-aminocarbonyl)-2,4-dihydro-3H-1,2,4-triazol-3-one.

10. The composition according to claim 1, wherein the second component is 2-chloro-N-(2-ethyl-6-methylphenyl)-N-[(1-methylethoxy)methyl]acetamide.

11. The composition according to claim 1, wherein the second component is 2-[(2-chlorophenyl)methyl]-4,4-dimethyl-3-isoxazolidinone and 3-cyclohexyl-6-dimethylamino-1-methyl-1,3,5-triazine-2,4(1H,3H)-dione.

12. The composition according to claim 1, wherein the second component is 4-methyl-2-chlorophenoxyacetic acid.

13. The composition according to claim 12, further comprising an adjuvant.

14. The composition according to claim 13, wherein the adjuvant is an ethoxylated propoxylated fatty amine or a polyether-polymethylsiloxane-copolymer.

15. The composition according to claim 1, further comprising a herbicidally acceptable diluent or carrier.

16. The composition according to claim 1, wherein the second component is present in the composition in an amount ranging from 0.001 to 1000 parts by weight per part by weight of the first component.

17. The composition according to claim 1, wherein the second component is present in the composition in an amount ranging from 0.02 to 500 parts by weight per part by weight of the first component.

18. The composition according to claim 1, wherein the second component is present in the composition in an amount ranging from 0.05 to 100 parts by weight per part by weight of the first component.

19. The composition according to claim 1, wherein the composition is in a solid or liquid form of an emulsifiable concentrate, wettable powder, granule, dust, oil spray or aerosol.

20. The composition according to claim 1, wherein the composition provides synergistic control of one or more weeds.

21. The composition according to claim 20, wherein the weed is selected from the group consisting of Amaranthus, Digitaria, Cyperus and Euphorbia.

22. A method for selective control of weeds, comprising contacting a composition comprising a synergistic effective amount of a combination of a first compound and a second component onto a crop plant or a non-crop area in need of weed control or at risk of undesirable weeds, in an amount effective to provide weed control in the crop, wherein said first compound is a compound of the formula (I) 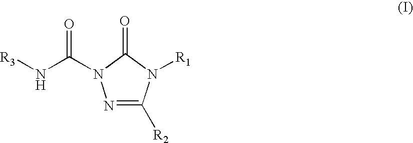
wherein:
R₁ is selected from the group consisting of hydrogen, hydroxyl, amino, or in each case optionally substituted alkyl, alkenyl, alkinyl, alkoxy, alkenyloxy, alkinyloxy, alkylamino, alkenylamino, alkenylamino, alkylideneamino, dialkylamino, cycloalkyl, cycloalkylalkyl, aryl and arylalkyl, any of which may be optionally substituted;
R₂ is selected from the group consisting of alkyl, alkenyl, alkinyl, alkoxy, alkenyloxy, alkinyloxy, alkylthio, alkenylthio, alkinylthio, alkylamino, alkenylamino, alkinylamino, dialkylamino, cycloalkyl, cycloalkyloxy, cycloalkylalkyl, aryl, aryloxy, arylthio, arylamino and arylalkyl, any of which may be optionally substituted;
R₃ is selected from the group consisting of alkyl, alkenyl, alkinyl, cycloalkyl, cycloalkylalkyl, arylalkyl, arylalkenyl and arylalkinyl, any of which may be optionally substituted; and
said second component is selected from 2-[(2-chlorophenyl)methyl]-4,4-dimethyl-3-isoxazolidinone, 3-cyclohexyl-6-dimethylamino-1-methyl-1,3,5-triazine-2,4(1H,3H)-dione, 4-methyl-2-chlorophenoxyacetic acid, 2-chloro-4-(ethylamine)-6-(isopropylamine)-s-triazine, N-ethyl-N′-(1-methylethyl)-6-(methylthio)-1,3,5-triazine-2,4-diamine, N-(3,4-dichlophenyl)-N,N-dimethyl urea, 5-cyclopropyl-4-(2-methylsulfonyl-4-trifluoromethylbenzoyl)isoxazole, 4-amino-6-tert-butyl-4,5-dihydro-3-methyltio-1,2,4-triazin-5-one, 1-(5-tert-butyl-1,3,4-thiadiazol-2-yl)-1,3-dimethylurea, 2′,4′-dichloro-5′-(4-difluoromethyl-4,5-dihydro-3-methyl-5-oxo-1H-1,2,4-triazol-1-yl)methanesulfonanilide, 2-(4-mesyl-2-nitrobenzoyl)cyclohexane-1,3-dione, N-(phosphonomethyl)glycine, dimethylamine salt of 2,4-dichlorophenoxyacetic acid, an herbicide of the chloroacetamide class, and mixtures thereof.

23. The method according to claim 22, wherein the herbicide of the chloroacetamide class is selected from 2-chloro-N-(2-ethyl-6-methylphenyl)-N-[(1-methylethoxy)methyl]acetamide, 2-chloro-N-ethoxymethyl-6′-ethylacet-o-toluidide, 2-chloro-N-(2-ethyl-6-methylphenyl)-N-(2-methoxy-1-methylethyl)acetamide, 2-chloro-N-(2-ethyl-6-methylphenyl)-N-[(1S)-2-methoxy-1-methylethyl]acetamide, 2-chloro-N-(2,6-diethylphenyl)-N-(methoxymethyl)acetamide, and N-(butoxymethyl)-2-chloro-N-(2,6-diethylphenyl)acetamide, N-[[(2Z)-2-butenyloxy]methyl]-2-chloro-N-(2,6-diethylphenyl)acetamide, 2-chloro-N-(2,6-dimethylphenyl)-N-[(2-methylpropoxy)methyl]acetamide, N-(chloroacetyl)-N-(2,6-diethylphenyl)glycine, 2-chloro-N-(2,6-dimethylphenyl)-N-(2-methoxyethyl)acetamide, 2-chloro-N-(2,6-dimethylphenyl)-N-(1H-pyrazol-1-ylmethyl)acetamide, 2-chloro-N-(2,6-diethylphenyl)-N-(2-propoxyethyl)acetamide, 2-chloro-N-(1-methylethyl)-N-phenylacetamide, 2-chloro-N-(1-methyl-2-propynyl)-N-phenylacetamide, N-(butoxymethyl)-2-chloro-N-[2-(1,1-dimethylethyl)-6-methylphenyl]acetamide, 2-chloro-N-(2,6-dimethylphenyl)-N-[(3-methoxy-2-thienyl)methyl]acetamide, and 2-chloro-N-(2,3-dimethylphenyl)-N-(1-methylethyl)acetamide.

24. The method according to claim 22, wherein the crop plant is selected from the group consisting of cereals, rice, maize, sorghum, sugar cane, cotton, canola, turf, barley, potato, sweet potato, sunflower, rye, oats, wheat, corn, soybean, sugar beet, tobacco, safflower, tomato, alfalfa, pineapple and cassava.

25. The method according to claim 22, wherein the second component is selected from the group consisting of N-ethyl-N′-(1-methylethyl)-6-(methylthio)-1,3,5-triazine-2,4-diamine, N-(3,4-dichlophenyl)-N,N-dimethyl urea, 5-cyclopropyl-4-(2-methylsulfonyl-4-trifluoromethylbenzoyl)isoxazole and 4-amino-6-tert-butyl-4,5-dihydro-3-methyltio-1,2,4-triazin-5-one.

26. The method according to claim 25, wherein the crop plant is selected from the group consisting of sugar cane, pineapple, cassava, turf and pasture.

27. The method according to claim 22, wherein the composition further comprises 2-[(2-chlorophenyl)methyl]-4,4-dimethyl-3-isoxazolidinone and/or 3-cyclohexyl-6-dimethylamino-1-methyl-1,3,5-triazine-2,4(1H,3H)-dione.

28. The method according to claim 27, wherein the crop plant is sugar cane, turf and pasture.

29. The method according to claim 22 wherein the composition further comprises 4-methyl-2-chlorophenoxyacetic acid.

30. The method according to claim 29, wherein the composition further comprises an adjuvant.

31. The method according to claim 30, wherein the adjuvant is an ethoxylated propoxylated fatty amine or a polyether-polymethylsiloxane-copolymer.

32. The method according to claim 29, wherein the crop plant is sugar cane, turf and pasture.

33. The method according to claims 22, wherein the first compound is 4-amino-5-isopropyl-2-(tert-butyl-aminocarbonyl)-2,4-dihydro-3H-1,2,4-triazol-3-one.

34. The method according to claims 22, wherein the composition is contacted at an application rate of from 0.01 kg/ha to 5.00 kg/ha of the first compound and from 0.5 kg/ha to 10.00 kg/ha of the second component to the crop.

35. The method according to claims 22, wherein the composition is contacted at an application rate of from 0.03 kg/ha to 3.00 kg/ha of the first compound to the crop.

36. The method according to claims 22, wherein the composition is contacted at an application rate of from 0.05 kg/ha to 5.00 kg/ha of the second component to the crop.

37. The method according to claims 22, wherein the composition is applied as a pre-emergence treatment.

38. The method according to claims 22-32, wherein the composition is applied as a post-emergence treatment.

39. The method according to claims 22-32, wherein the weed is selected from the group consisting of Amaranthus, Digitaria, Cyperus and Euphorbia.
